(19) United States
(12) Patent Application Publication
(10) Pub. No.: US 2011/0074752 A1
(43) Pub. Date: Mar. 31, 2011

(54) DISPLAY-MODE CONTROL DEVICE AND RECORDING MEDIUM RECORDING DISPLAY-MODE CONTROL PROGRAM

(76) Inventor: Masaaki KIKUCHI, Tokyo (JP)

(21) Appl. No.: 12/891,834

(22) Filed: Sep. 28, 2010

(30) Foreign Application Priority Data
Sep. 29, 2009 (JP) 2009-225633

(51) Int. Cl. G09G 5/10

(52) U.S. Cl. 345/207

(57) ABSTRACT

A display-mode control device comprises a display-mode controller which acquires picked-up image data representing a picked-up image ahead of a display face of a display unit, specifies, using the acquired picked-up image data and an illumination position specifying a position of illumination in an image set beforehand, brightness of a position corresponding to the illumination position in the picked-up image as brightness of illumination, and controls a display mode based on the specified brightness of the illumination.

### CROSS-REFERENCE TO RELATED APPLICATION

This application claims the benefit of Japanese Patent Application No. 2009-225633, filed on Sep. 29, 2009, the entire disclosure of which is incorporated by reference herein.

### FIELD

This application relates generally to a display-mode control device and a recording medium recording a display-mode control program.

### BACKGROUND

An example of such a technology is a display-mode control device which controls a display mode a display unit in accordance with a period or a time set beforehand and which reduces power consumption of a display device having the display unit. An example of such a display unit is a liquid crystal display or an OEL (Organic Electro-Luminescence) display. An example of such a display device is a digital photo stand or a personal computer which displays a digital photo or the like on the display unit. The display-mode control device may be the display device itself in some cases. A display mode for reducing power consumption is, for example, a power-saving mode of displaying a screen saver on the display unit. According to such a power-saving mode, when there is no operation input to the display device given by a user during a preset period, or when it becomes a preset time, a control of, for example, darkening the display face of the display unit or terminating power supply to the display unit is performed, thereby accomplishing power saving.

Unexamined Japanese Patent Application KOKAI Publication No. 2002-189450 discloses a technology of detecting brightness around the display device through an illumination sensor provided on the front face or the like of the display device, and of performing no display-mode control when the controller determines that the surroundings is bright, or of performing display-mode control when the controller determines that the surroundings is dark.

According to the former technology, however, when it becomes a period or a time set beforehand, the display mode is subjected to control even if a user is using the display device, so that the display face of the display device is made darkened and the power supply to the display unit is terminated when in use. According to the latter technology, the display mode is not controlled if the surroundings of the display device is bright by sunlight in the daytime even if a user is not present in a room. As explained above, the conventional technologies perform display-mode control without considering an activity of the user, so that it is not user-friendly for the user.

The present invention has been made in view of the foregoing problems, and it is an object of the present invention to provide a display-mode control device and a recording medium recording a display-mode control program which control a display mode in accordance with an activity of a user.

### SUMMARY

A display-mode control device according to a first aspect of the present invention controls a display mode of a display unit, and comprises: an illumination-position specifying unit which acquires first picked-up image data representing a first picked-up image ahead of a display face of the display unit, specifies, using the acquired first picked-up image data, brightness at each divisional area acquired by dividing the first picked-up image, and specifies, based on the specified brightness for each divisional area, a position of a divisional area where an illumination candidate in the first picked-up image is reflected as an illumination position; and a display-mode controller which acquires second picked-up image data representing a second picked-up image ahead of the display face of the display unit, specifies, using the acquired second picked-up image data and the illumination position specified by the illumination-position specifying unit, brightness of a divisional area located at a position corresponding to the illumination position as brightness of illumination, and controls the display mode based on the specified brightness of illumination.

A display-mode control device according to a second aspect of the present invention controls a display mode of a display unit, and comprises: a display-mode control unit which acquires picked-up image data representing a picked-up image ahead of a display face of the display unit, specifies, using the acquired picked-up image data and a predetermined area in an image set beforehand, brightness of a position corresponding to the predetermined area in the picked-up image as brightness of illumination, and controls the display mode based on the specified brightness of illumination.

A recording medium according to a third aspect of the present invention stores a display-mode control program that allows a computer which controls a display mode of a display unit to execute: an illumination-position specifying step of acquiring first picked-up image data representing a first picked-up image ahead of a display face of the display unit, of specifying, using the acquired first picked-up image data, brightness at each divisional area acquired by dividing the first picked-up image, and of specifying, based on the specified brightness for each divisional area, a position of a divisional area where an illumination candidate in the first picked-up image is reflected as an illumination position; and a display-mode controlling step of acquiring second picked-up image data representing a second picked-up image ahead of the display face of the display unit, of specifying, using the acquired second picked-up image data and the illumination position specified in the illumination-position specifying step, brightness of a divisional area located at a position corresponding to the illumination position as brightness of illumination, and of controlling the display mode based on the specified brightness of illumination.

According to the display-mode control device and the display-mode control program of the present invention, it becomes possible to control a display mode in accordance with an activity of a user.

### BRIEF DESCRIPTION OF THE DRAWINGS

A more complete understanding of this application can be obtained when the following detailed description is considered in conjunction with the following drawings, in which:

FIG. 1 is a block diagram showing a relationship among individual units of a display-mode control device according to a first embodiment of the present invention;

FIG. 2 is a diagram showing a hardware configuration of the display-mode control device of the first embodiment;

FIG. 3 is a front view of the display-mode control device of the first embodiment as viewed from the front;

FIG. 4 is a flowchart for an illumination-position specifying process executed by the display-mode control device of the first embodiment;

FIG. 5A shows a first picked-up image represented by picked-up image data;

FIG. 5B shows the first-picked-up image divided into individual predetermined divisional areas;

FIG. 6A shows a data structure for picked-up image data and an image number and an acquired time both associated with the picked-up image data;

FIG. 6B shows a data structure for divisional-area brightness data;

FIG. 6C shows a data structure for illumination candidate data;

FIG. 6D shows a data structure for illumination position data;

FIG. 7 is a flowchart for a display-mode control process executed by the display-mode control device of the first embodiment;

FIG. 8 is a flowchart for a light-up/light-off process executed by the display-mode control device of the first embodiment;

FIG. 9 is a flowchart for the light-up/light-off process executed by the display-mode control device of the first embodiment;

FIG. 10A shows a state in which illumination in a picked-up image is turned off;

FIG. 10B shows a state in which illumination in the picked-up image is hidden by an obstacle;

FIG. 11 is a block diagram showing a relationship among individual units of a display-mode control device according to a second embodiment of the present invention;

FIG. 12 is a diagram showing a hardware configuration of the display-mode control device of the second embodiment;

FIG. 13 is a flowchart for a displacement detecting process executed by the display-mode control device of the second embodiment;

FIG. 14 is a diagram showing a picked-up image represented by past (most recent) picked-up image data;

FIG. 15 is a diagram showing a picked-up image represented by present picked-up image data shifted parallel to the left from a past picked-up image.

FIG. 16 is a diagram showing a picked-up image represented by present picked-up image data shifted to the left and rotated by 90 degree from a past picked-up image;

FIG. 17 is a flowchart for an illumination position designating process executed by the display-mode control device of the second embodiment; and

FIG. 18 is a diagram for explaining a pattern matching carried out by the display-mode control device of the second embodiment.

### DETAILED DESCRIPTION

### First Embodiment

An explanation will be given of a first embodiment of the present invention with reference to the accompanying drawings. It should be understood that the present invention is not limited to the following embodiments and drawings. The following embodiments and drawings can be changed and modified without departing from the scope and the spirit of the present invention. A display-mode control device of the present invention is realized by, for example, a computer.

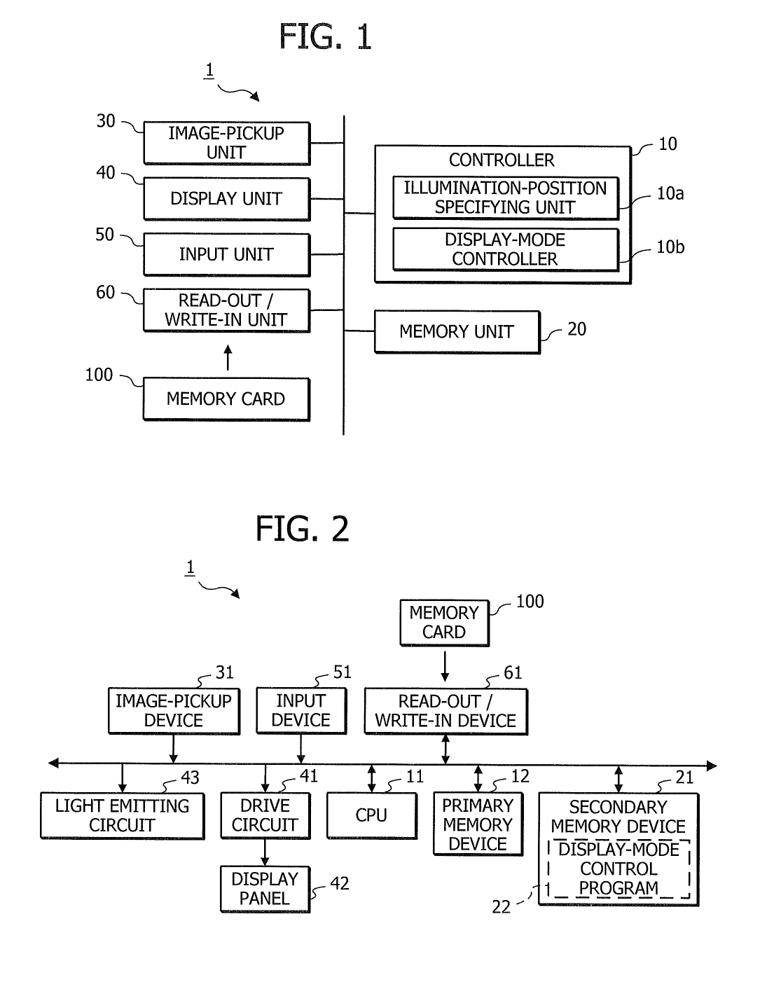

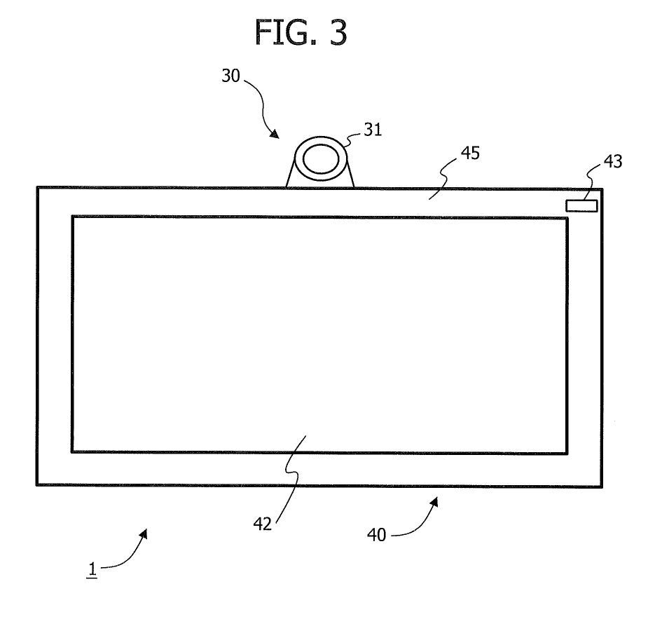

First, an illustrative configuration of a display-mode control device 1 will be explained with reference to FIG. 1. The display-mode control device 1 of the present embodiment is a digital photo stand (which is sometimes referred to as a digital photo frame) (see FIG. 3). The digital photo stand displays and plays an image like a digital photo picked up by, for example, a digital camera.

The display-mode control device 1 of the present embodiment has an image-pickup device 31 (image-pickup unit 30) which picks up an image ahead of the display face of a display panel 42 (display unit 40) of the display-mode control device 1, and the display-mode control device 1 specifies a position of illumination, such as a fluorescent lamp or a light bulb provided in a room, based on picked-up image data representing the picked-up image and acquired by an image-pickup operation by the image-pickup device 31. The display-mode control device 1 determines a light-up/light-off state of illumination at the specified illumination position for each piece of picked-up image data acquired for each predetermined time, and controls a display mode in accordance with a determination result.

The display-mode control device 1 has a controller 10, a memory unit 20, the image-pickup unit 30, the display unit 40, an input unit 50, and a read-out/write-in unit 60. At least some of the functions of individual units may be built in another device communicationable with the display-mode control device 1 via a network.

The controller 10 controls individual units to control the whole display-mode control device 1. The controller 10 has an illumination-position specifying unit 10a and a display mode controller 10b, and those units specify the position of illumination and control the display mode as explained above.

As needed, the memory unit 20 stores, under the control of the controller 10, data generated by the controller 10 during a process, and various data like recorded image data read from a memory card 100 by the read-out/write-in unit 60.

At least a part of the image-pickup unit 30 is fixed to a frame or the like of the display unit 40 so that an image-pickup lens is directed to the front of the display face of the display unit 40 (see FIG. 3). The image-pickup unit 30 picks up an image ahead of the display face of the display unit 40 under the control of the controller 10. The front of the display face is, for example, at least a part of directions in which light emitted from the display face propagates, or a direction within a certain angular range from the normal line of the display face. The image-pickup unit 30 picks up an image ahead of the display face of the display unit 40, generates a picked-up image signal representing a picked-up still image, and generates digital still-image original data based on the generated picked-up image signal. The image-pickup unit 30 supplies the generated still-image original data to the controller 10.

The display unit 40 displays, under the control of the controller 10, a picked-up image ahead of the display face of the display unit 40 picked up by the image-pickup unit 30, an operation screen, and a recorded image or the like represented by the recorded image data recorded in the memory card 100 and read by the read-out/write-in unit 60.

The input unit 50 is an operation unit receiving an operation input given by a user, and supplies operation input data corresponding to a content of the received operation input to the controller 10.

The read-out/write-in unit 60 reads, under the control of the controller 10, recorded image data recorded in the memory card 100, and supplies the read data to the controller 10.

The memory card 100 comprises, for example, a flash-memory-type memory card. An example of such a memory card is an SD memory card recording recorded image data representing a picked-up image (digital photo, etc.) picked up by a digital camera.

Next, with reference to FIG. 2, an explanation will be given of an illustrative hardware configuration of the display-mode control device 1. The display-mode control device 1 has a CPU (Central Processing Unit) 11, a primary memory device 12, a secondary memory device 21, the image-pickup device 31, a drive circuit 41, a display panel 42, an input device 51, and a read-out/write-in device 61.

The controller 10 shown in FIG. 1 comprises, for example, the CPU 11 and the primary memory device 12. The controller 10 may include the CPU 11, and an ASIC (Application Specific Integrated Circuit), etc. In this case, a process on image data among all processes executed by the CPU 11 may be executed by the ASIC, etc. The ASIC is, for example, a DSP (Digital Signal Processor). The primary memory device 12 comprises a RAM (Random Access Memory).

The memory unit 20 in FIG. 1 comprises the secondary memory device 21. The secondary memory device 21 comprises a flash memory or a hard disk, etc. The secondary memory device 21 stores a display-mode control program 22.

The CPU 11 reads the display-mode control program 22 from the secondary memory device 21 into the primary memory device 12, and executes a process to be discussed later based on an instruction from the read display-mode control program 22. The primary memory device 12 functions as a working memory or the like for the CPU 11. Data received by the CPU 11 and data supplied from the CPU 11 are once stored in the memory area of the primary memory device 12. The CPU 11 reads data recorded in the primary memory device 12, performs calculation using the read data, and stores data on a calculation result in the primary memory device 12. The illumination-position specifying unit 10a and the display mode controller 10b both possessed in the controller 10 each comprises the CPU 11 which executes a process to be discussed later in accordance with the display-mode control program 22 and the primary memory device 12.

The primary memory device 12 and the secondary memory device 21 stores, as needed, data generated through a process to be discussed later and various data like recorded image data read from the memory card 100. Various data stored in the primary memory device 12 and in the secondary memory device 21 is deleted or overwritten on another data as needed by the CPU 11.

The image-pickup unit 30 shown in FIG. 1 comprises the image-pickup device 31 (see FIG. 3). The image-pickup device 31 has at least a part fixed to a frame 45 or the like of the display panel 42 so that the image-pickup lens is directed to the front of the display face of the display panel 42 (see FIG. 3). The image-pickup device 31 comprises a camera including an image-pickup element, such as a CCD (Charge Coupled Device) image sensor or a CMOS (Complementary Metal Oxide Semiconductor) image sensor.

The image-pickup element generates still-image original data representing a picked-up image acquired by an image pickup operation. That is, the image-pickup device 31 generates a picked-up image signal representing a still image ahead of the display panel 42 (display unit 40) by the image-pickup element, and performs a control process on the generated picked-up image signal by means of various circuits, thereby generating digital still-image original data. Note that examples of such a control process are correlated double sampling, automatic gain control performed on a picked-up image signal having undergone sampling, analog/digital conversion of converting an analog picked-up image signal having undergone automatic gain control into a digital signal.

A still-image original data is data representing an image by what corresponds to one frame, and includes pixel values of respective effective pixels of the image-pickup element. The image-pickup device 31 supplies the generated still-image original data to, for example, the primary memory device 12. The primary memory device 12 stores the still-image original data received from the image-pickup device 31.

The display unit 40 in FIG. 1 comprises the drive circuit 41, the display panel 42, a light emitting circuit 43, and the frame 45. The CPU 11 generates RGB data (RED-GREEN-BLUE data) to be displayed using various image data, and supplies the generated RGB data to the drive circuit 41 via the primary memory device 12. The drive circuit 41 drives the display panel 42 based on the received RGB data, and supplies various images represented by various image data to the display panel 42. The display panel 42 comprises, for example, a liquid crystal display panel or an OEL (Organic Electro-Luminescence) display panel, etc. The display panel 42 displays various images received from the drive circuit 41. The light emitting circuit 43 is for notifying the user whether or not a process by the display-mode control device 1 is normally executed, and emits light under the control of the controller 10. The light emitting circuit 43 comprises, for example, an LED (Light Emitting Diode). The light emitting circuit 43 is fixed to the frame 45 or the like of the display panel 42 (see FIG. 3).

The input unit 50 (operation unit) in FIG. 1 comprises the input device 51. The input device 51 is an interface device operated by the user, and includes plural operation keys, such as a play key, a stop key, a menu key, a display-control-mode select key, a set key, and a power key. As the user operates such a key, the input device 51 supplies operation input data corresponding to the individual key to the primary memory device 12. The primary memory device 12 receives operation input data supplied from the input device 51, and stores the received operation input data. The CPU 11 executes a process to be discussed later in accordance with the operation input data stored in the primary memory device 12.

Note that the display unit 40 and the input unit 50 may together comprise a touch panel. In this case, the display panel 42 and the input device 51 are together configured by a touch panel. The touch panel displays a predetermined input screen and supplies operation input data to the primary memory device 12.

The read-out/write-in unit 60 in FIG. 1 comprises the read-out/write-in device 61. The read-out/write-in device 61 is an interface device which reads out and writes in data. The read-out/write-in device 61 reads recorded image data recorded in the memory card 100, and supplies the read data to the primary memory device 12. The primary memory device 12 receives the recorded image data supplied from the read-out/write-in device 61, and stores the received data. The CPU 11 executes a process to be discussed later using the recorded image data stored in the primary memory device 12.

Next, an explanation will be given of processes executed by the display-mode control device 1. The processes executed by the display-mode control device 1 are an illumination-position specifying process and a display-mode control process. The display-mode control device 1 successively acquires multiple pieces of recorded image data from the memory card 100 through the following process unless it becomes a power-saving mode, and successively displays respective recorded images represented by acquired recorded image data.

The illumination-position specifying process executed by the display-mode control device 1 is initiated with an operation of the input unit 50 given by the user being as a trigger. For example, the user turns on the display-mode control device 1 using the input unit 50, and selects activation of an automatic display-control mode from a screen for selecting a display control mode displayed on the display unit 40. Accordingly, the input unit 50 supplies operation input data corresponding to the operation given by the user to the controller 10, and the controller 10 receives operation input data from the input unit 50. In accordance with this operation, the illumination-position specifying unit 10a executes the illumination-position specifying process. Until the illumination-position specifying process ends, automatic control of the display mode is disabled, so that it is desirable to give a notification to the user by lighting up the light emitting circuit 43 under the control of the controller 10 (CPU 11) during this process. Moreover, it is desirable that the illumination-position specifying process should be executed at a time point at which no illumination position is specified.

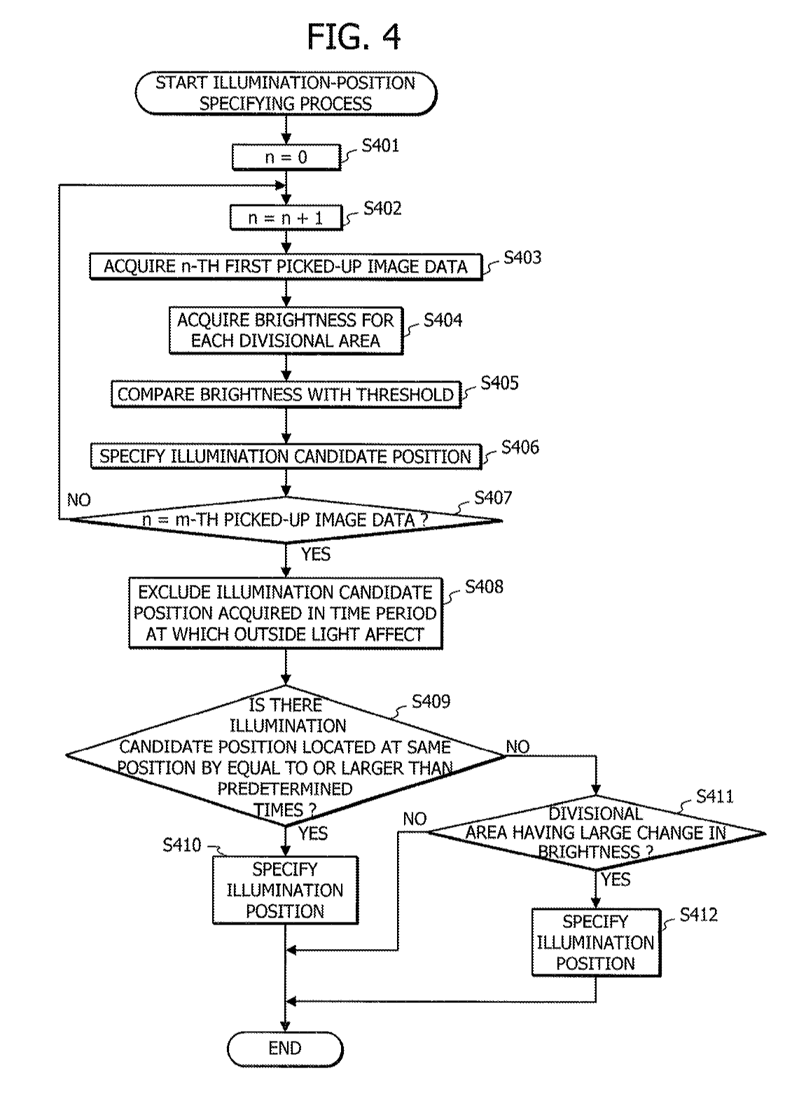

The illumination-position specifying unit 10a executes the illumination-position specifying process (see FIG. 4). First, the illumination-position specifying unit 10a causes the image-pickup unit 30 to picks up an image ahead of the display face of the display unit 40. The illumination-position specifying unit 10a executes a process of specifying a position of illumination provided in a room based on picked-up image data (i.e., first picked-up image data) representing a picked-up image (i.e., a first picked-up image 501) acquired through the image-pickup operation. The illumination-position specifying unit 10a causes the image-pickup unit 30 to pick up an image for each predetermined time, and acquires first picked-up image data representing a first picked-up image for each predetermined time. In the present embodiment, first picked-up image data are acquired once every one hour, 24 times at total.

First, the illumination-position specifying unit 10a sets as n=0 (step S401). n is a number given to picked-up image data acquired by the illumination-position specifying unit 10a. Next, the illumination-position specifying unit 10a sets as n=n+1 (step S402).

Under the control of the illumination-position specifying unit 10a, the image-pickup unit 30 picks up an image. The image-pickup unit 30 generates a picked-up image signal representing a still image (the first picked-up image 501) of the front of the display face of the display unit 40, and generates digital still-image original data based on the generated picked-up image signal. The image-pickup unit 30 supplies the generated still-image original data to the illumination-position specifying unit 10a. The illumination-position specifying unit 10a receives the still-image original data supplied from the image-pickup unit 30, performs necessary control processes, such as contour enhancement, white balance adjustment, gamma correction, and compression, on the received still-image original data, and converts such data into YUV (brightness and color difference) data. Accordingly, the illumination-position specifying unit 10a acquires the YUV data by what corresponds to one image as n-th first picked-up image data, and stores (saves) it (step S403).

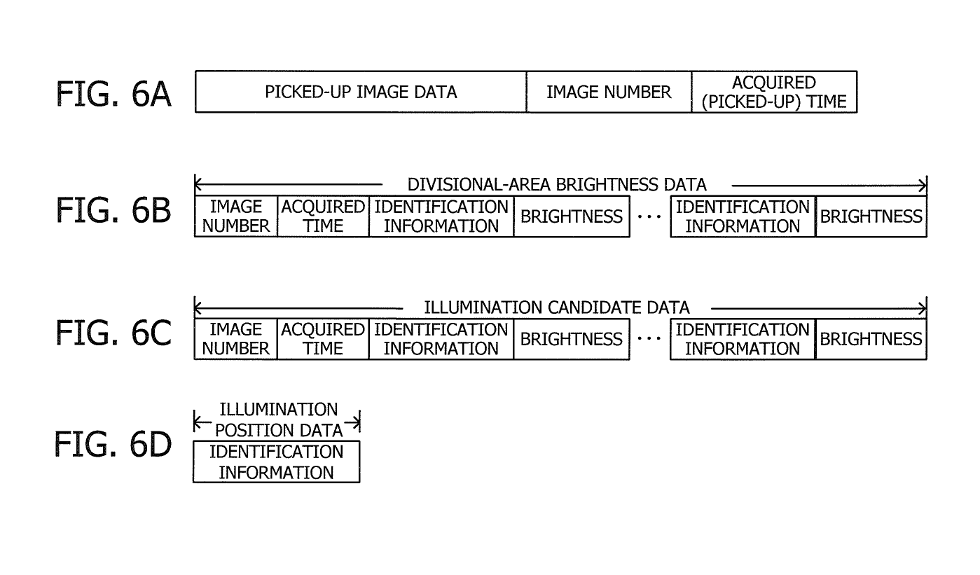

At this time, the illumination-position specifying unit 10a stores the acquired first picked-up image data in association with an image number (i.e., the n) and an acquisition time (which is acquired by means of a non-illustrated timer) (or records it in the primary memory device 12). FIG. 6A shows a data structure in which picked-up image data is associated with a picked-up image number and an acquisition time. Note that in addition to the foregoing YUV data, the picked-up image data may be YUV data with adjusted side and resolution, RGB data acquired by converting such data, or compressed data acquired by compressing such data. Moreover, the first picked-up image data may be stored in the memory unit 20 (the secondary memory device 21) at an arbitrary timing.

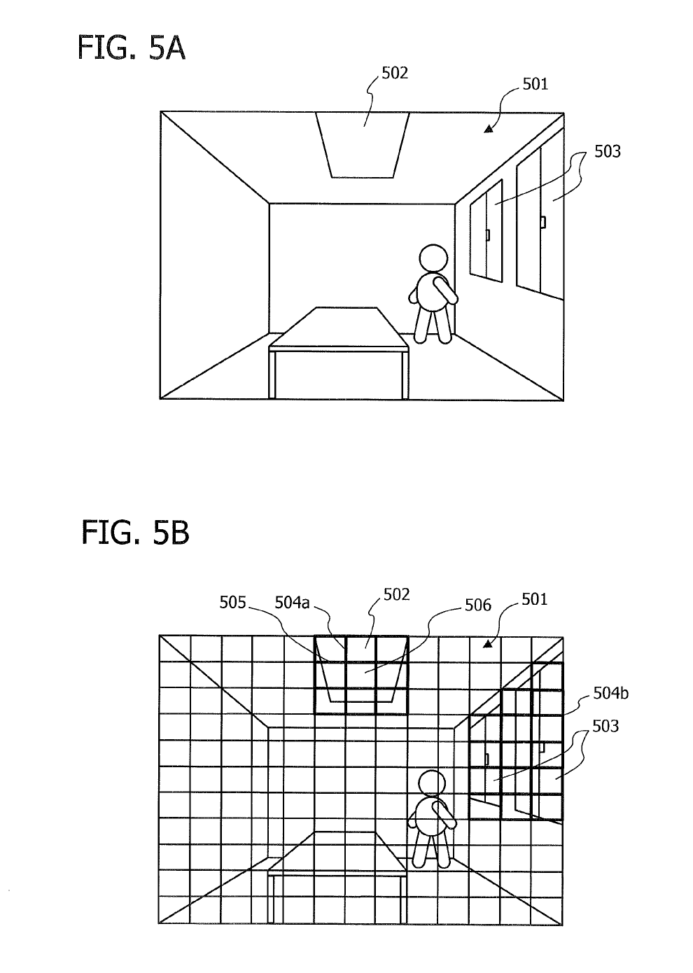

Next, the illumination-position specifying unit 10a divides the first picked-up image 501 (see FIG. 5A) represented by the acquired first picked-up image data into multiple predetermined areas (i.e., divisional areas) (see FIG. 5B). In the present embodiment, the picked-up image data is evenly divided into divisional areas 11 in vertical by 13 in horizontal, but the number of divisional areas can be set arbitrary, and individual divisional areas may not be divided evenly. The position of the divisional area and the size thereof are set beforehand, and those unchanged during the process. A position of the divisional area can be specified from identification information (in the present embodiment, an identification number) which is set beforehand and which is unique for a position of each divisional area in the first picked-up image 501. For example, a divisional area at uppermost and leftmost in the first picked-up image in FIG. 5B is set as the first area, the uppermost and rightmost divisional area is set as the thirteenth area, and a divisional area at leftmost and the second from the uppermost row is set as the fourteenth area. The divisional area can be specified in this fashion.

Furthermore, the illumination-position specifying unit 10a acquires, using a brightness value or numerical information on brightness like an RGB value acquired for each pixel in each divisional area, brightness of each divisional area (data for specifying brightness) by calculating an average value or an additional value of those brightness values, etc. (step S404). The brightness may be calculated based on a brightness value or an RGB value acquired for each pixel from all pixels in the divisional area, or may be calculated selectively from predetermined number of pixels at predetermined positions in the divisional area set beforehand, or, may be calculated based on a brightness value or an RGB value acquired arbitrary.

In this fashion, the illumination-position specifying unit 10a acquires brightness of each divisional area of the first picked-up image 501 using the first picked-up image data. At this time, for each divisional area, the illumination-position specifying unit 10a generates divisional-area brightness data including information associating identification information for the divisional area with brightness of the divisional area specified by this identification information, an image number, and an acquisition time. The generated divisional-area brightness data is stored (or records it in the primary memory device 12). FIG. 6B shows a data structure for divisional-area brightness data.

Subsequently, the illumination-position specifying unit 10a compares brightness of each divisional area with a threshold (a first threshold) set beforehand (step S405). The first threshold is a value for specifying illumination. The value for specifying illumination is set as a brightness level that a fluorescent lamp or a light bulb provided in a room can have (e.g., 200 tones among 255 tones).

Using the comparison result in the step S405, the illumination-position specifying unit 10a specifies a position of the divisional area with brightness equal to or higher than the first threshold (or brightness higher than the first threshold) (step S406). This position is referred to as an illumination candidate position which is the position of the divisional area where a candidate of illumination is reflected (hereinafter, an illumination candidate position). The illumination-position specifying unit 10a associates the identification information for specifying an illumination candidate position with brightness of the illumination candidate area at the illumination candidate position, and stores those pieces of information as illumination candidate data (or records it in the primary memory device 12). The illumination candidate data includes the image number and the acquisition time. FIG. 6C shows an example of illumination candidate data.

In FIG. 5A, the first picked-up image 501 has one illumination 502 and two windows 503. The illumination-position specifying unit 10a compares brightness with the first threshold, and as shown in FIG. 5B, specifies nine divisional areas corresponding to the illumination 502 as illumination candidate areas 504a. Moreover, the illumination-position specifying unit 10a specifies fifteen divisional areas corresponding to the windows 503 as illumination candidate positions 504b. The illumination-position specifying unit 10a specifies respective positions of those illumination candidate areas as illumination candidate positions (step S406).

After specifying illumination candidate positions based on the first picked-up image data by what corresponds to one image, the illumination-position specifying unit 10a determines whether or not the image number “n” associated with the illumination candidate position information is a predetermined number “m” (step S407). The predetermined number “m” indicates the number of pieces of first picked-up image data picked up and acquired by the illumination-position specifying unit 10a for each predetermined time in the illumination-position specifying process. In the present embodiment, because the illumination-position specifying unit 10a acquires picked-up image data once every one hour, and 24 times at total, the predetermined number is set as “m=24”.

When determining that “n≠m” (step S407: NO), the illumination-position specifying unit 10a returns the process to the step S402 after a predetermined time (in the present embodiment, one hour) elapses, and sets as n=n+1 (i.e., in the present embodiment, n=2) (step S402). Thereafter, the illumination-position specifying unit 10a executes the process from the step S403 to the step S406, and specifies illumination candidate positions based on the first picked-up image data by one image.

When determining that “n=m” (i.e., n=24) (step S407: YES), the illumination-position specifying unit 10a executes a following process, and specifies an illumination position in a picked-up image based on a illumination candidate position specified for each predetermined period. The illumination-position specifying unit 10a does not use illumination candidate data that a certain time (in the present embodiment, 24 hours) has elapsed for specification of illumination. That is, the illumination-position specifying unit 10a (the CPU 11) deletes illumination candidate data or the like that the certain time (i.e., 24 hours) has elapsed from the memory area of the primary memory device 12.

The illumination-position specifying unit 10a excludes illumination candidate data in a period of time at which outside light affects among multiple pieces of illumination candidate data (illumination candidate positions) generated for each predetermined period from a use target so that such illumination candidate data is not used for identification of an illumination position (step S408). As shown in FIG. 5B, the illumination candidate areas specified in the step S406 include a divisional area where the window 503 is reflected by outside light (i.e., sunlight) coming in through the window 503 present in the room, and such divisional area has a possibility of being specified as an illumination candidate position. The illumination-position specifying unit 10a does not use illumination candidate data including data acquired between, for example, 6A.M. and 6 P.M. which is a period of time at which outside light affects (e.g., the illumination-position specifying unit 10a deletes illumination candidate data including data acquired in this period of time). That is, the illumination-position specifying unit 10a specifies an illumination position based on illumination candidate data acquired in the night (e.g., from 6 P.M. to 6 A.M., may be changed depending on seasons, and set appropriately) which is a period of time at which no outside light affects. In this fashion, the illumination-position specifying unit 10a uses the first picked-up image data representing the first picked-up image 501 having a picked-up time satisfying a predetermined criterion (e.g., a period of time (daytime) other than night).

Next, the illumination-position specifying unit 10a determines whether or not an illumination candidate position is located at the same location by equal to or more than predetermined times through multiple pieces of first picked-up image data acquired for each predetermined period among illumination candidate positions specified for each predetermined time (step S409). This determination is made by referring to identification information forming illumination candidate data. For example, it is determined whether or not there is illumination candidate data having the same identification information by equal to or more than three times in multiple pieces of first picked-up image data. When it is determined that there is such data (step S409: YES), the illumination-position specifying unit 10a specifies an illumination candidate position specified by the identification information of such illumination candidate data as an illumination position (step S410). The illumination-position specifying unit 10a generates illumination position data for specifying the illumination position, and stores it (or records it in the primary memory device 12). The illumination position data is for specifying a position of the divisional area where illumination is possibly reflected, and more specifically, such data is configured by identification information specifying this position (see FIG. 6D).

The divisional area on which an object is reflected and which is located at the illumination position specified in this fashion has brightness exceeding a certain level for a predetermined period even through it is in the night that no outside light affects, and such an area is highly possibly an area of illumination lighted up for a long time. Accordingly, the illumination-position specifying unit 10a specifies the position of the divisional area as the illumination position.

Conversely, when determining that there is no illumination candidate position located at the same position by equal to or more than the predetermined number (step S409: NO), the illumination-position specifying unit 10a checks a change in brightness for each divisional area located at the illumination candidate position. That is, it is checked whether or not a difference in or a ratio of brightness of individual divisional areas located at the illumination candidate position is equal to or higher than a second threshold (or is higher than the second threshold) for multiple pieces of first picked-up image data (step S411). More specifically, illumination candidate data for arbitrary two first picked-up images among multiple pieces of first picked-up images is compared with divisional-area brightness data. That is, brightness corresponding to each piece of identification information included in the illumination candidate data is compared with brightness corresponding to the same identification information as the foregoing identification information included in the divisional-area brightness data. This comparison is carried out for each first picked-up image. Note that the second threshold corresponds to brightness generated by lighting-up/lighting-off of illumination.

When determining that there is a divisional area having a large change in brightness (step S411: YES), the illumination-position specifying unit 10a specifies the position of the divisional area having this brightness as an illumination position (step S412). The illumination-position specifying unit 10a generates illumination position data for specifying the illumination position, and stores it (or records it in the primary memory device 12). This illumination position data generated in this step has the same data structure as the foregoing one (see FIG. 6D).

An object reflected on the divisional area located at the illumination position specified in this fashion has a large change in brightness, and such an area is highly possibly an area where illumination changing its brightness largely by lighting-up/lighting-off is reflected. Accordingly, the illumination-position specifying unit 10a specifies the position of such a divisional area as the illumination position.

When determining that there is no divisional area having a large change in brightness (step S411: NO), the illumination-position specifying unit 10a terminates the process. At this time, the illumination-position specifying unit 10a was unable to specify an illumination position, and displays information to the effect that it is unable to control a display mode to be discussed later on the display unit 40.

Through the above-explained process, an illumination position is specified based on an illumination candidate position acquired for each predetermined time, and the illumination-position specifying process completes. Accordingly, the illumination-position specifying unit 10a does not specify the fifteen divisional areas corresponding to the windows 503 and acquired as illumination candidate position information in FIG. 5B as an illumination position (those areas are bright in the daytime, and are excluded from the illumination candidate areas in the step S408). Conversely, respective positions of the nine divisional areas corresponding to the illumination 502 are acquired as illumination positions. Note that the illumination position data is recorded in the memory unit 20 accordingly, and is read in a predetermined process to be discussed later.

The illumination-position specifying unit 10a may refer to the specified illumination position (identification information), and when there are illumination positions adjoining to each other, the divisional areas located at those illumination positions may be taken as divisional areas where the same illumination is reflected based on the referred illumination positions, and individual divisional areas adjoining to each other in this fashion may be taken as a group of illumination positions (hereinafter, an illumination area group). That is, in FIG. 5B, the illumination-position specifying unit 10a specifies respective positions of the nine divisional areas corresponding to the illumination 502 as illumination positions, but because individual divisional areas adjoin to each other, it may be determined that illumination positions with the same illumination being as a target are specified, and the nine divisional areas can be taken as the illumination area group. In this case, a representative divisional area for the illumination area group may be set. For example, in the case of the illumination area group shown in FIG. 5B, a divisional area representing a center of the divisional area group may be set as a representative divisional area 506. When there is no divisional area representing the center, a divisional area specified at random among the divisional areas located in the vicinity of the center may be set as the representative divisional area 506. In this a case, the illumination-position specifying unit 10a specifies a position of at least one divisional area in the divisional area group as an illumination position. Lighting-up/lighting-off of illumination can be determined as will be discussed later even through this scheme (the illumination turns on/off as a whole), resulting in reduction of a process load.

After the illumination-position specifying unit 10a specifies the illumination position, the display-mode controller 10b acquires second picked-up image data (the same data as the first picked-up image data) for each predetermined period. Thereafter, a display-mode control process is executed which determines brightness of the illumination position in the picked-up image based on the acquired second picked-up image and the illumination position acquired by the illumination-position specifying unit 10a.

Like the illumination-position specifying process, the display-mode controller 10b acquires the second picked-up image data for each certain period. This certain period may be same as the predetermined period set for the illumination-position specifying process, or may be set differently. In the present embodiment, for example, the display-mode controller 10b causes the image-pickup unit 30 to pick up an image once every ten minutes to acquire the second picked-up image. The second picked-up image is acquired through the same scheme as that of the illumination-position specifying process, so that duplicated explanation will be skipped here.

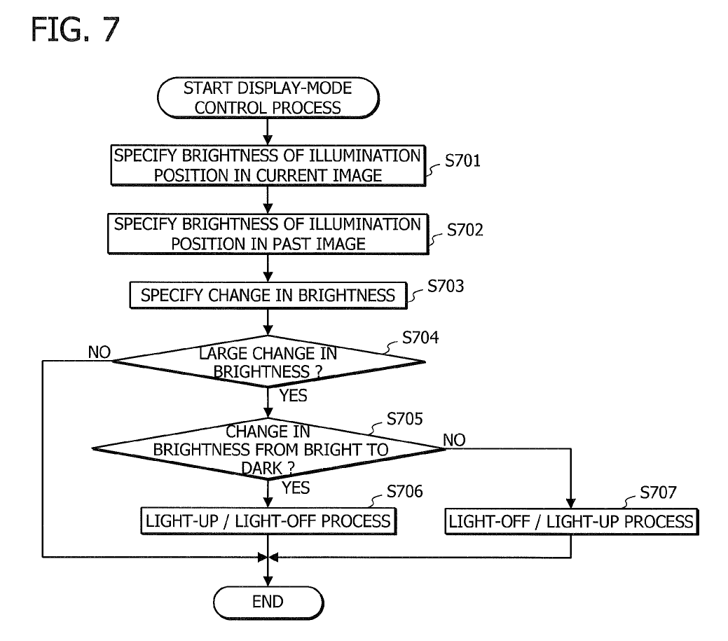

Like the illumination-position specifying process, the display-mode controller 10b specifies brightness of each divisional area based on the acquired second picked-up image (generates divisional-area brightness data and stores it). Brightness of each divisional area is specified through the same scheme as that of the illumination-position specifying process, so that duplicated explanation will be skipped here. The display-mode controller 10b stores equal to or greater than predetermined number of information on brightness of individual divisional areas for each second picked-up image in a time series, and specifies brightness of each divisional area for equal to or more than two second picked-up images. Every time a process of specifying brightness from after the second divisional area is executed, a display-mode control process shown in FIG. 7 is executed.

In the following explanation, the latest second picked-up image data among all second picked-up image data acquired by the display-mode controller 10b is referred to as current image data, and a second picked-up image represented by the current image data is referred to as a current image. Moreover, in the following explanation, second picked-up image data acquired right before the latest second picked-up image data among all second picked-up image data acquired by the display-mode controller 10b is referred to as past image data, and a second picked-up image represented by the past image data is referred to as a past image. Furthermore, a divisional area located at an illumination position is referred to as an illumination area.

The display-mode controller 10b specifies brightness of an illumination area located at an illumination position in a current image represented by the current image data by referring to divisional-area brightness data on the current image data (step S701). The display-mode controller 10b specifies, based on identification information on illumination position data, brightness corresponding to that identification information, thereby to specify brightness of an illumination area located at the illumination position. The display-mode controller 10b stores (or records in the primary memory device 12) a value of the brightness as current-image brightness information (including identification information and brightness corresponding to each piece of identification information accordingly). Note that when multiple illumination areas are specified, for example, an average value of brightness of respective illumination areas is specified as brightness of the illumination areas.

The display-mode controller 10b specifies brightness of the illumination area located at the illumination position in the past image represented by the past image data by referring to divisional-area brightness data on the past image data (step S702). The display-mode controller 10b specifies, based on identification information on illumination position data, brightness corresponding to that identification information, thereby to specify brightness of the illumination area located at the illumination position. The display-mode controller 10b stores (or records in the primary memory device 12) a value of this brightness as past-image brightness information (including identification information and brightness corresponding to each piece of identification information accordingly). Note that when multiple illumination areas are specified, for example, an average value of brightness of respective illumination areas is specified as brightness of the illumination areas.

The display-mode controller 10b compares brightness of the illumination area in the current image with brightness of the illumination area in the past image, and specifies a change (a difference, a ratio, etc.,) in brightness of the illumination area (step S703).

The display-mode controller 10b determines whether or not a change in the specified brightness is large (step S704). This determination is made whether or not a value of such change is equal to or larger than a third threshold (or exceeds the third threshold, the same is true in the following explanation). The third threshold is set as a value of change in brightness originating from a change in illumination (a change in state from lighting-up to a lighting-off of illumination or from lighting-off to lighting-up of illumination). If a value of change is a difference in brightness, an absolute value of such difference is set to be as a value in change.

When a value of change is less than the third threshold (or equal to or less than the third threshold, the same is true in the following explanation), the display-mode controller 10b determines that a change in the specified brightness is little (step S704: NO). When a value of change is less than the third threshold (or equal to or less than the third threshold, the same is true in the following explanation), this means the brightness remains substantially same or a change is little, and it can be considered that there is no change in illumination. When the display-mode controller 10b determines that a change in the specified brightness is little (step S704: NO), it can be considered as explained above that there is no change in illumination, so that it is unnecessary to change a display mode, and the display-mode controller 10b completes the process.

When a value of change is equal to or larger than the third threshold, the display-mode controller 10b determines that a change in the specified brightness is large (step S704: YES). When a value of change is equal to or larger than the third threshold, the brightness has largely changed, so that it can be considered that there is a change in illumination. When the display-mode controller 10b determines that a change in the specified brightness is large (step S704: YES), it can be considered as explained above that there is a change in illumination, so that it is necessary to change a display mode. Accordingly, the display-mode controller 10b determines whether or the change in the brightness is a change in a state from lighting-up (a bright state) to lighting-off (a dark state) (step S705). The determination in the step S705 can be made by using a value of change in brightness.

When a value of change is acquired based on a difference in brightness (acquired by subtracting brightness of the illumination area of the past image from brightness of the illumination area of the current image), if the value of change is a negative value, this means a value of rightness of the illumination area in the current image is smaller than a value of brightness of the illumination area in the past image. In this case, the illumination area has changed from a “bright state” to a “dark state”. That is, illumination reflected on the illumination area possibly has changed its state from lighting-up to lighting-off. Conversely, when the value of change is a positive value, a brightness of the illumination area in the current image is larger than a value of brightness of the illumination area in the past image, so that the illumination area has changed from a “dark state” to a “bright state”. That is, illumination reflected on the illumination area possibly has changed its state from lighting-off to lighting-up. When the value of change is a negative value, the display-mode controller 10b determines that illumination has changed its state from lighting-up to lighting-off (step S705: YES), and executes a light-up/light-off process (step S706). Moreover, when the value of change is a positive value, the display-mode controller 10b determines that the illumination has changed its state from lighting-off to lighting-up (step S705: NO), and executes a light-off/light-up process (step S707).

When a value of change is acquired based on a ratio of brightness (acquired by dividing brightness of the illumination area in the current image by brightness of the illumination area in the past image), if the value of change is less than one, this means a value of brightness of the illumination area in the current image is smaller than a value of brightness of the illumination area in the past image. In this case, the illumination area has changed from a “bright state” to a “dark state”. That is, illumination reflected on this illumination area has possibly changed its state from lighting-up to lighting-off. Conversely, when the value of change exceeds one, this means a value of brightness of the illumination area in the current image is larger than a value of brightness of illumination area in the past image, so that the illumination area has changed from a “dark state” to a “bright state”. That is, illumination reflected on the illumination area has possibly changed its state from lighting-off to lighting-up. When the value of change is less than one, the display-mode controller 10b determines that the illumination has changed its state from lighting-up to lighting-off (step S705: YES), executes a light-up/light-off process (step S706), and terminates the process. When the value of change exceeds one, the display-mode controller 10b determines that the illumination has changed its state from lighting-off to lighting-up (step S705: NO), executes a light-off/light-up process (step S707), and terminates the process.

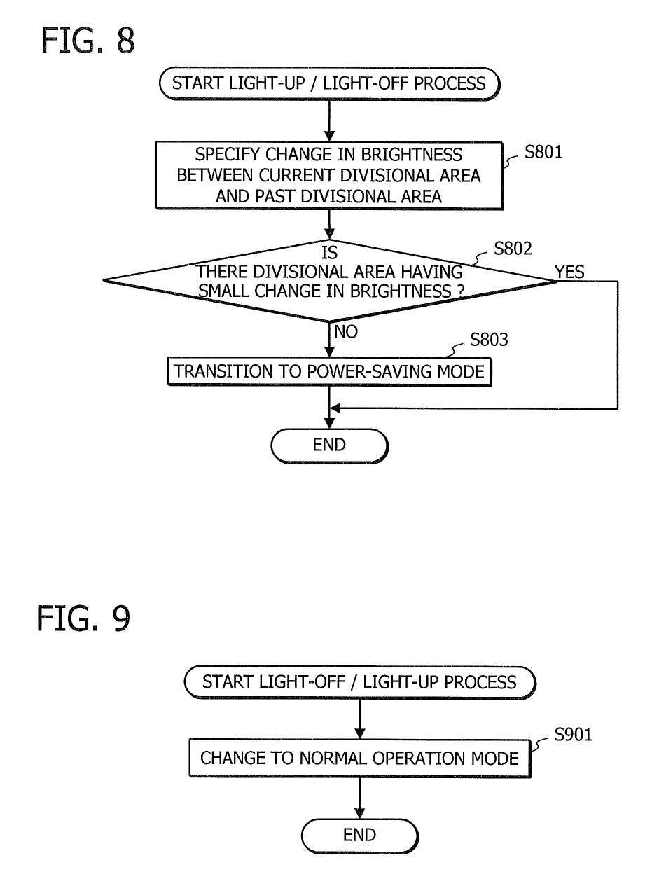

An explanation will now be given of the light-up/light-off process executed by the display-mode controller 10b with reference to FIG. 8. The display-mode controller 10b compares brightness of each divisional area of the current image specified as explained above with brightness of each divisional area of the past image, and specifies a change in brightness of each divisional area (step S801). The display-mode controller 10b calculates, using divisional-area brightness data on the past image data and divisional-area brightness data on the current image data, a change (a difference or a ratio) in brightness corresponding to the same identification information for each piece of identification information, and stores data representing a calculation result (or records it in the primary memory device 12).

The display-mode controller 10b determines whether or not there is a divisional area having little change among all specified changes in brightness of each divisional area (step S802). The display-mode controller 10b determines whether or not there is a divisional area having a value of change in brightness equal to or less than a fourth threshold (or less than the fourth threshold, the same is true in the following explanation), thereby to determine whether or not there is a divisional area having little change. The fourth threshold is set to be a value smaller than a value of change in brightness caused by lighting-up/lighting-off of illumination. When there is a divisional area equal to or less than the fourth threshold, the display-mode controller 10b determines that there is a divisional area having little change.

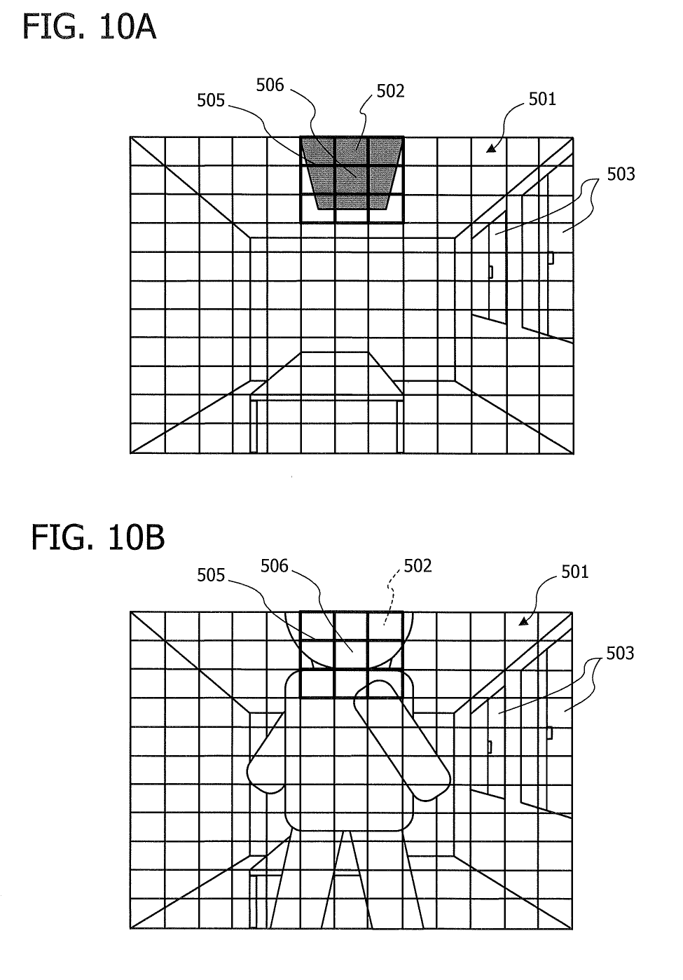

When there is no divisional area having little change (step S802: NO), it can be determined that the illumination 502 becomes a light-off state from a light-up state. That is, in this case, it can be anticipated that positions other than the illumination position in a picked-up image has changed from a “bright state” to a “dark state” like the illumination position. In this case, it can be anticipated that brightness in the room becomes dark as a whole as the illumination becomes a light-off state from a light-up state, so that there is a high possibility that no one is present in the room reflected on the picked-up image (see FIG. 10A). In accordance with a determination result, the display-mode controller 10b darkens the display face (the display panel 42) of the display unit 40, terminates power supply to the display unit 40, or displays a screen saver to perform display-mode control of changing a display mode to a power-saving mode (step S803). When the display mode is already the power-saving mode, the display-mode controller 10b maintains the power-saving mode. When no one is present in the room, it is unnecessary to display a digital photo or the like on the display unit.

Conversely, when there is a divisional area having little change (step S802: YES), the illumination area becomes dark but other divisional areas do not become dark in this case. That is, in this case, there is a high possibility that just an obstacle like a person or an object is present ahead of the image-pickup unit 30 and the illumination has not been turned off yet (see FIG. 10B). In this case, a person may be still in the room, so that the display-mode controller 10b does not perform display-mode control and terminates the process.

An explanation will now be given of the light-off/light-up process executed by the display-mode controller 10b with reference to FIG. 9. In this process, there is a high possibility that anyone enters the room because the illumination is turned on. The display-mode controller 10b changes the display mode to a normal operation mode (a mode of successively displaying recorded images (digital photos)) (step S901). When the display mode is already the normal operation mode, the display mode controller 10b maintains the normal operation mode.

As explained above, the display-mode control device 1 of the present embodiment controls the display mode of the display unit, and has the illumination-position specifying unit 10a and the display-mode controller 10b. The illumination-position specifying unit 10a acquires first picked-up image data representing a first picked-up image reflecting the front of the display face of the display unit 40, specifies brightness of each divisional area acquired by dividing the first picked-up image using the acquired first picked-up image data, and specifies a position of a divisional area on which an illumination candidate in the first picked-up image is reflected as an illumination position based on the specified brightness of each divisional area. Moreover, the display-mode controller 10b acquires second picked-up image data representing a second picked-up image reflecting the front of the display face of the display unit 40, specifies, as brightness of the illumination, brightness of a divisional area located at a position corresponding to the illumination position in the second picked-up image using the acquired second picked-up image data and the illumination position specified by the illumination-position specifying unit 10a, and controls the display mode based on specified brightness of the illumination. It is highly possible that illumination keeps turning on if anyone is present in the room. The display-mode control device 1 controls the display mode in accordance with the state of illumination as explained above, so that the display mode can be controlled in accordance with an activity of the user.

Moreover, as explained above, the illumination-position specifying unit 10a specifies an illumination position using first picked-up image data representing a first picked-up image data having a picked-up time satisfying the predetermined criterion. Accordingly, it is possible to prevent the display-mode control device 1 from falsely recognizing a window or the like where outside light comes as illumination.

The illumination-position specifying unit 10a acquires multiple pieces of first picked-up image data, specifies brightness of each divisional area for each of the multiple pieces of acquired first picked-up image data, and specifies a position of a divisional area whose brightness satisfies the first criterion for each piece of first picked-up image data using the specified brightness. Accordingly, the display-mode control device 1 can have an improved precision for specifying an illumination position.

The illumination-position specifying unit 10a specifies, as an illumination position, a divisional area whose brightness satisfies the first criterion equal to or larger than predetermined successive times for each piece of first picked-up image data. Accordingly, the display-mode control device 1 can have an improved precision for specifying an illumination position.

The illumination-position specifying unit 10a specifies, as the foregoing illumination position, a position of the divisional area having a change in brightness satisfying the predetermined second criterion. Accordingly, the display-mode control device 1 can have an improved precision for specifying the illumination position.

The display-mode controller 10b acquires multiple pieces of second picked-up image data, and specifies brightness of illumination multiple times using the multiple pieces of acquired second picked-up image data, specifies a state change in brightness of the illumination based on the specified multiple pieces of information on brightness of the illumination, and controls the display mode based on the specified change state. Accordingly, the display-mode control device 1 can highly precisely detect the state of illumination, and can control the display mode based on the detected illumination state.

The display-mode controller 10b switches the display mode to the power-saving mode when a state changes to a state becoming dark and when a change level of the state change satisfies the third criterion. Accordingly, the display-mode control device 1 can highly precisely detect the state of illumination, and can control the display mode based on the detected illumination state.

When the state changes to a state becoming dark, the display-mode controller 10b detects a change in brightness of a divisional area other than a divisional area corresponding to an illumination position in a second picked-up image represented by multiple pieces of second picked-up image data, and does not switch the display mode to the power-saving mode when the change in brightness of the divisional area satisfies the fourth criterion. Accordingly, even if there is any obstacle or the like, the display-mode control device 1 can detect the state of illumination highly precisely, and can control the display mode based on the detected illumination state.

When the state changes to a state becoming bright and when a change level of the state change satisfies the fifth criterion, the display-mode controller 10b switches the display mode to another mode from the power-saving mode. Therefore, display-mode control device 1 can control the display mode precisely based on the detected illumination state.

In the present embodiment, the display-mode controller 10b specifies an illumination position acquired by the illumination-position specifying unit 10a, and determines, using the specified illumination position, a state of the illumination position in a second picked-up image represented by second picked-up image data acquired for each certain period. However, the configuration of the display-mode control device 1 of the present invention is not limited to the foregoing one. That is, until the illumination-position specifying unit 10a specifies an illumination position, the display-mode controller 10b may temporarily specify an illumination candidate position acquired by the illumination-position specifying unit 10a as an illumination position. Using this illumination position, a state of the illumination position in the second picked-up image represented by the second picked-up image acquired for each certain time may be determined. Hence, a term illumination position is a concept also including a temporal illumination position. The user is allowed to freely select whether or not to control the display mode using a temporal illumination position and to make such a setting. An illumination position or the like may be a predetermined area set by the user accordingly. In this case, the illumination-position specifying unit 10a becomes unnecessary in some cases. Even in this case, it is possible for the display-mode control device 1 to control the display mode in accordance with any activity of the user.

### Second Embodiment

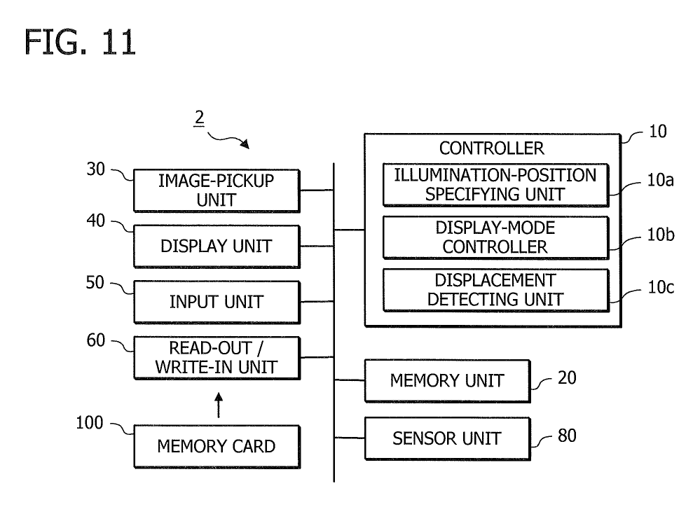

An explanation will now be given of a second embodiment of the present invention with reference to the accompanying drawings. In the second embodiment, the same structural element as that of the first embodiment will be denoted by the same reference numeral, and the duplicated explanation will be skipped below. FIG. 11 is a block diagram showing a configuration of a display-mode control device 2 according to the second embodiment. In addition to the configuration of the display-mode control device 1 of the first embodiment, the display-mode control device 2 has the controller 10 that further includes a displacement detecting unit 10c which detects any displacement of the display unit 40. Moreover, the display-mode control device 2 has a sensor unit 80. Furthermore, the display-mode control device 2 of the present embodiment receives an operation of specifying an illumination position given by the user and executes a process of causing the illumination-position specifying unit 10a to specify an illumination position in response to the received operation.

The sensor unit 80 detects any displacement, rotation, vibration, etc., of the display-mode control device 2. The sensor unit 80 supplies sensor data corresponding to each detection result to the controller 10.

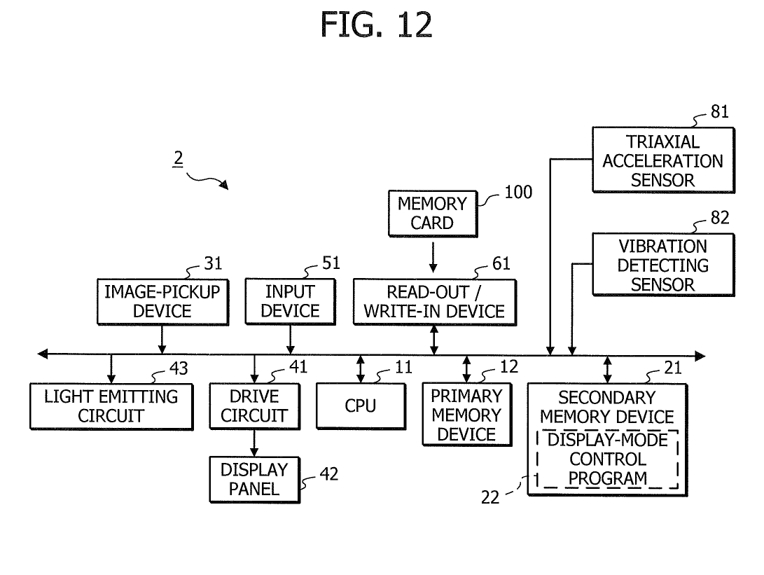

FIG. 12 is a block diagram showing a hardware configuration of the display-mode control device 2 of the present embodiment. The display-mode control device 2 has a triaxial acceleration sensor 81, and a vibration detecting sensor 82 in addition to the configuration of the display-mode control device 1 of the first embodiment.

The sensor unit 80 shown in FIG. 11 comprises the triaxial acceleration sensor 81 and the vibration detecting sensor 82. The triaxial acceleration sensor 81 is built in a digital photo stand (the display-mode control device 2). The triaxial acceleration sensor 81 measures respective acceleration in all three axes of X, Y, and Z by a single element, and detects accelerations when the display-mode control device 2 is displaced or rotated. The triaxial acceleration sensor 81 supplies acceleration sensor data to the primary memory device 12 when detecting any displacement or rotation of the display-mode control device 2. The vibration detecting sensor 82 is also built in the digital photo stand (the display-mode control device 2). The vibration detecting sensor 82 detects any vibration of the display-mode control device 2. The vibration detecting sensor 82 supplies vibration sensor data to the primary memory device 12 when detecting any vibration of the display-mode control device 2.

The displacement detecting unit 10c comprises the CPU 11 and the primary memory device 12.

Regarding the display-mode control device 2 having the configuration as explained above, an explanation will now be given of a control process executed by the display-mode control device 2. In the following explanation, a displacement detecting process executed by the displacement detecting unit 10c will be explained and the explanation for the illumination-position specifying process and the display-mode control process explained in the first embodiment will be skipped.

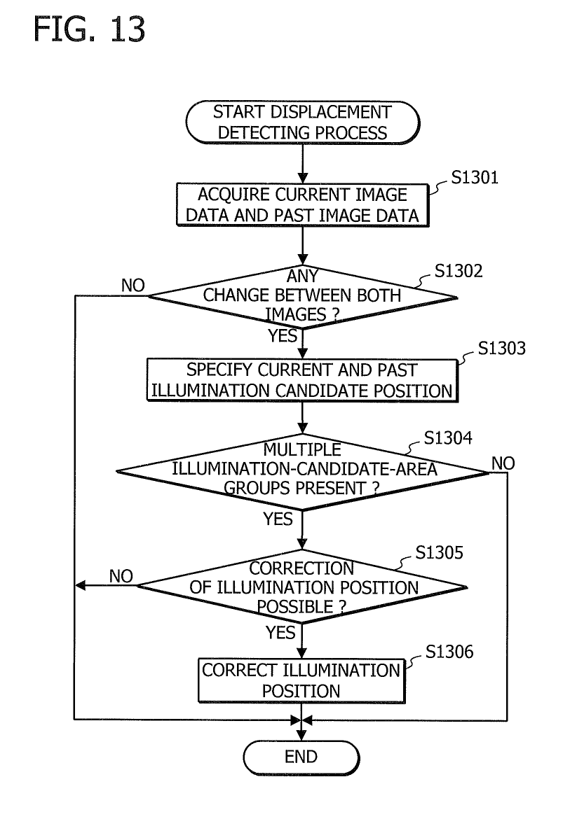

The displacement detecting process executed by the displacement detecting unit 10c will be explained with reference to FIG. 13. The displacement detecting unit 10c repeatedly executes this process at a certain time interval in parallel with the processes executed by the illumination-position specifying unit 10a and by the display-mode controller 10b. The displacement detecting unit 10c starts the process with an operation of the input unit 50 given by the user being as a trigger. For example, the user turns on the display-mode control device 2 using the input unit 50, and selects activation of an automatic display control mode from a screen to select a display control mode displayed on the display unit 40. Accordingly, the input unit 50 supplies operation input data corresponding to the operation given by the user to the controller 10, and the controller 10 receives operation input data from the input unit 50. In response to this data reception, the displacement detecting unit 10c starts executing the displacement detecting process.

The displacement detecting unit 10c acquires current image data and past image data (step S1301). Those pieces of image data may be the first picked-up image data and the second picked-up image data acquired by the illumination-position specifying unit 10a and the display-mode controller 10b, respectively, or may be pieces of picked-up image data acquired by the displacement detecting unit 10c itself for each certain period. The displacement detecting unit 10c stands by until acquiring current image data after past image data is acquired, and progresses the process to a following process after the current image data is acquired.

The displacement detecting unit 10c specifies brightness of each divisional area in the current image and in the past image based on the acquired current image data and past image data, and determines whether or not there is any change between the picked-up images using the specified brightness (step S1302). For example, between both images, a change in images at four corners set beforehand in the picked-up images is detected. When a change in the images of the four corners (e.g., a displacement level of a background) satisfies a predetermined condition, it is possible for the displacement detecting unit 10c to determine that the background is moving. When a change in the images of the four corners does not satisfy the predetermined condition, it is possible for the displacement detecting unit 10c to determine that the background is not moving. A change in the images of the four corners can be detected through a conventionally well-known technique based on, for example, a motion vector, difference absolute value sum, or difference square sum.

As a result of this determination, when any change between both images is found (step S1302: YES), the displacement detecting unit 10c recognizes that illumination position information or illumination candidate position information acquired by the illumination-position specifying unit 10a is changed as the display-mode control device 2 (including the display unit 40) is displaced, and executes a process of correcting the illumination position information or the illumination candidate position information (i.e., a process of re-specifying an illumination position again). At this time, the displacement detecting unit 10c keeps saving past image data right before the change occurs (hereinafter, the saved past image is referred to as saved data, and an image represented by the saved data is referred to as a saved image).

Conversely, when there is no change between both images (step S1302: NO), the displacement detecting unit 10c recognizes that the illumination position information or the illumination candidate position information acquired by the illumination-position specifying unit 10a remains same, and terminates the process.

The displacement detecting unit 10c specifies an illumination candidate position based on the current image data and on the saved data (step S1303). That is, the displacement detecting unit 10c specifies an illumination candidate position before and after recognizing that an illumination position or an illumination candidate position is changed. How to specify the illumination candidate position is same as the technique explained in the first embodiment, so that the duplicated explanation will be skipped in the present embodiment.

Thereafter, the displacement detecting unit 10c determines whether or not the number of illumination-candidate-area groups in the current image and in the saved image is a plural number (step S1304). An illumination-candidate-area group means a collection of illumination candidate areas adjoining to one another, and the displacement detecting unit 10c makes the foregoing determination using the illumination-candidate-area group. Note that the illumination-candidate-area group can be specified by the above-explained specified illumination candidate positions. More specifically, the displacement detecting unit 10c specifies an illumination-candidate-area group based on identification information (which is information enabling specification of an illumination candidate position) included in the illumination candidate data. The displacement detecting unit 10c generates illumination-candidate-area-group data that specifies a position, a size, a shape, etc., of the illumination-candidate-area group in both images, and stores it (or records it in the primary memory device 12). In this fashion, the illumination candidate area is specified.

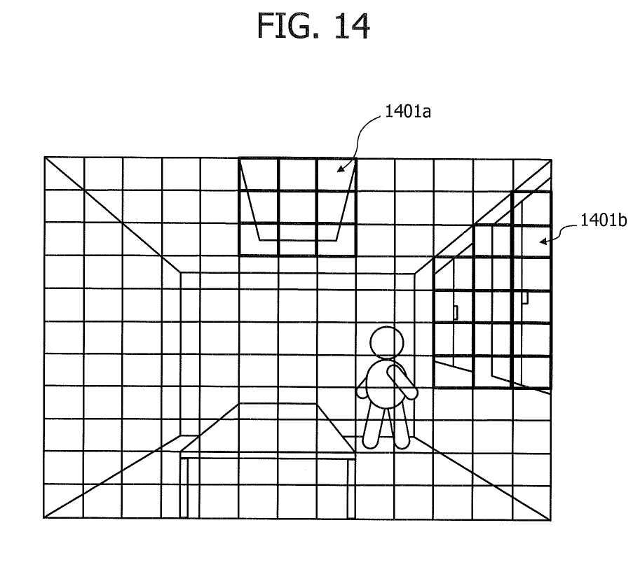

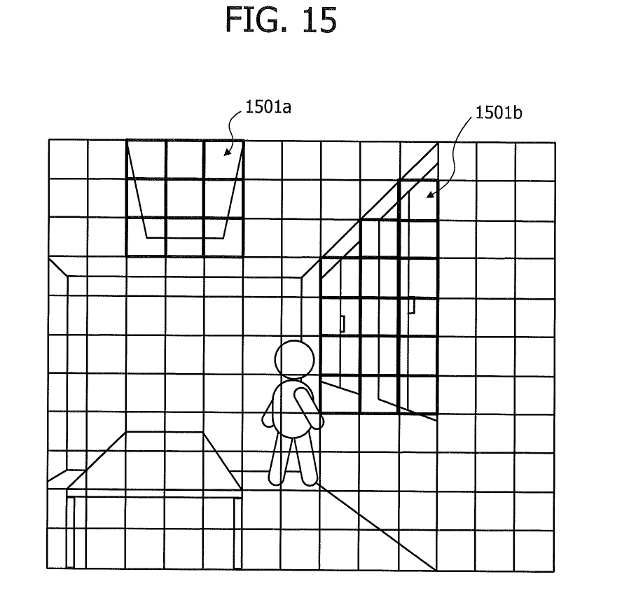

For example, FIG. 14 shows two illumination-candidate-area groups 1401a and 1401b both specified based on illumination candidate positions in the saved image. FIG. 15 shows two illumination-candidate-area groups 1501a and 1501b both specified based on illumination candidate positions in the current image. In this case, because respective numbers of illumination-candidate-area groups in the current image and in the saved image are both a plural number (two), the displacement detecting unit 10c determines that the number of illumination-candidate-area groups in the current image and in the saved image is a plural number.

As a result of determination by the displacement detecting unit 10c, when it is determined that the number of illumination-candidate-area groups in the current image and in the saved image is not a plural number (step S1304: NO), a process to be discussed below cannot be executed, so that the displacement detecting unit 10c terminates the process, and the illumination-position specifying unit 10a re-specifies an illumination candidate position or an illumination position again through the illumination-position specifying process explained in the first embodiment.

Conversely, as a result of determination by the displacement detecting unit 10c, when it is determined that the number of illumination-candidate-area groups in the current image and in the saved image is a plural number (step S1304: YES), the displacement detecting unit 10c executes, using a positional relationship among the specified illumination-candidate-area groups in the current image and in the saved image, a matching process (e.g., pattern matching to be discussed later), determines whether or not correction of the illumination position is possible, and determines whether or not correction of the illumination position based on a displacement detail specified in the last determination (step S1305). When it is not possible (step S1305: NO), as correction of the illumination position cannot be performed, the displacement detecting unit 10c terminates the process, and the illumination-position specifying unit 10a re-specifies an illumination candidate position or an illumination position again through the illumination-position specifying process explained in the first embodiment. When it is possible (step S1305: YES), as correction of the illumination position can be performed, the displacement detecting unit 10c corrects the illumination position (step S1306).

Specific examples of those processes will now be explained. For the save image, the displacement detecting unit 10c sets, for example, “1” to a divisional area in the illumination candidate area, and sets “0” to the other divisional areas. Next, the displacement detecting unit 10c generates first image data representing a first image having a pixel that is a divisional area under the foregoing setting. Such data can be generated by using the specified illumination candidate position Likewise, for the current image, the displacement detecting unit 10c sets “1” to a divisional area in the illumination candidate area, and sets “0” to the other divisional areas. Next, the displacement detecting unit 10c generates second image data representing a second image having a pixel that is a divisional area under the foregoing setting.

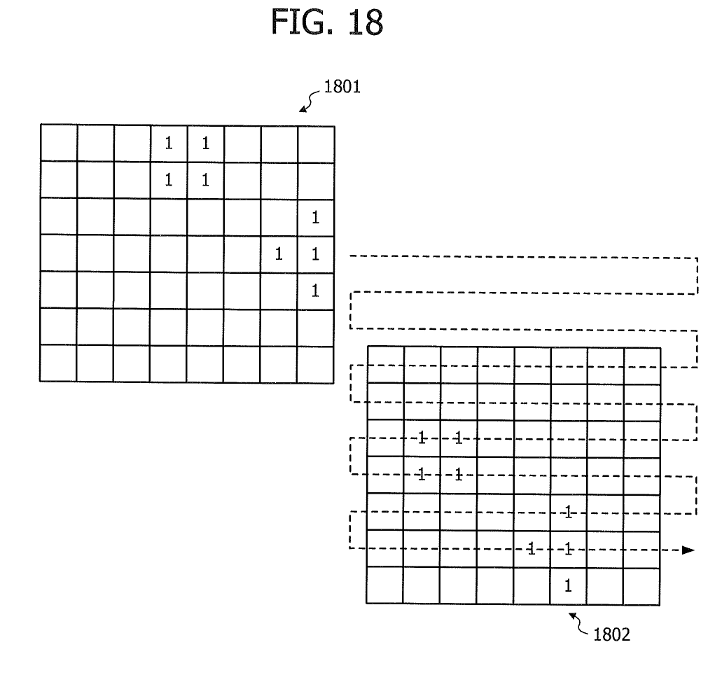

The displacement detecting unit 10c stores both generated first and second image data (or records it in the primary memory device 12). The displacement detecting unit 10c shifts, using the stored first and second image data, as shown in FIG. 18, a first image 1801 in the vertical direction and the horizontal direction one pixel by one pixel over a second image 1802 (see an arrow in FIG. 18). Next, a process (pattern matching) of specifying a relative position between both images where the number of pixels having the setting of “1” becomes maximum in both images is executed. When there are multiple relative positions specified, one of the relative positions is specified at random. The relative position can be grasped by detecting how much and in which direction the first image and the second image are shifted relative to each other. For example, it can be grasped based on, for example, by how many pixels a pixel at an arbitrary corner of both images is shifted. In FIG. 18, in order to facilitate understanding, a number “1” is put in only a pixel corresponding to a divisional area in the illumination candidate area, and nothing is put in the other pixels (pixels with the setting of 0). Moreover, the size of each pixel, the number of divisional areas, etc., differ from those of the image shown in FIG. 14.

After specifying the relative position between both images where the number of pixels having the setting of “1” becomes maximum, the displacement detecting unit 10c determines, for the pixels having the setting of “1”, whether or not equal to or larger than a predetermined criterion (e.g., equal to or greater than 90 percent) of multiple pixels overlap one another at the relative position. When equal to or larger than the predetermined criterion of multiple pixels overlap, the displacement detecting unit 10c determines that correction of the illumination position is possible, generates data specifying the relative position, and stores it as displacement detail data (or records it in the primary memory device 12). Data for specifying the relative position is data indicating by how many pixels and in which direction the first image and the second image are shifted relative to each other when the number of overlapping pixels having the setting of, for example, “1” becomes maximum. Thus way, the displacement detecting unit 10c can detect the displacement detail (the relative position) of the illumination position. Because a pixel corresponds to a divisional area, the displacement detail specifies the displacement direction and by how many pixels the displacement is made (e.g., shifted leftward by one pixel, and downward by four pixels).

When equal to or larger than the predetermined criterion of multiple pixels for the pixels having the setting of “1” do not overlap one another, the displacement detecting unit 10c rotates, using the stored first image data, the first image by 90 degree in the clockwise or counterclockwise direction around a pixel at an arbitrary corner (e.g., a corner on the viewer's lower left). This rotation is made by 90 degree by 90 degree such that the display-mode control device 2 rotates an image typically from a vertical arrangement to a transverse arrangement. Like the above explained process, first, the first image is shifted vertically and horizontally one pixel by one pixel over the second image, and a process of specifying a relative position between both images where the number of pixels having the setting of “1” becomes maximum in both images is executed. The relative position can be grasped by detecting the rotational direction of the second image, the rotational angle thereof, a pixel at the center of rotation (hereinafter, referred to as a rotational center pixel), and in which direction and how much the rotational center pixel in the rotated second image is shifted relative to a pixel corresponding to the rotational center pixel in the first image.

After specifying the relative position between both images where the number of pixels having the setting of “1” becomes maximum, the displacement detecting unit 10c determines, for the pixels having the setting of “1”, whether or not equal to or larger than a predetermined criterion (e.g., 90 percent) of multiple pixels overlap one another at the relative position in both images. When equal to or larger than the predetermined criterion of multiple pixels overlap one another, the displacement detecting unit 10c determines that correction of the illumination position is possible, generates data specifying the relative position, and stores it as displacement detail data (or records it in the primary memory device 12). Data for specifying the relative position is data indicating the rotational direction of the second image, the rotational angle thereof, the rotational center pixel, and how much and in which direction the rotational center pixel in the rotated second image is shifted relative to the pixel corresponding to the rotational center pixel in the first image when equal to or larger than the predetermined criterion (e.g., 90 percent) of multiple pixels overlap one another for the pixels having the setting of, for example, “1”. Thus way, the displacement detecting unit 10c can detect the displacement detail (the relative position) of the illumination position. Because a pixel corresponds to a divisional area, the displacement detail specifies the rotational direction, the rotational angle, the divisional area at the center of rotation, the displacement direction after rotation, and by how many divisional areas the displacement is made (e.g., rotated by 90 degree in the clockwise direction around a pixel at a lower left and shifted leftward by one pixel, and downward by four pixels).

When equal to or larger than the predetermined criterion of multiple pixels for the pixels having the setting of “1” do not overlap one another, the displacement detecting unit 10c rotates, using the stored first image data, the first image by 180 degree in the above-explained rotational direction around the rotational center pixel, and executes the same process as explained above. When equal to or larger than the predetermined criterion of pixels for the pixels having the setting of “1” do not overlap one another in this process, the displacement detecting unit 10c further rotates, using the stored first image, the first image by 270 degree in the above-explained rotational direction around the rotational center pixel, and executes the same process as explained above.

In the last process executed by the displacement detecting unit 10c, when equal to or larger than the predetermined criterion of multiple pixels for the pixels having the setting of “1” do not overlap one another, the displacement detecting unit 10c determines that it is unable to correct the illumination position (step S1305: NO), and terminates the process. The illumination-position specifying unit 10a re-specifies the illumination candidate position or the illumination position again through the illumination-position specifying process explained in the first embodiment.

When the displacement detecting unit 10c specifies the displacement detail using the positional relationship of illumination candidate areas (or illumination-candidate-area groups) as explained above, the displacement detecting unit 10c corrects, using the displacement detail data, the storing illumination position data or the illumination position data recorded in the memory unit 20, thereby correcting the illumination position. Thereafter, illumination position data specifying the corrected illumination position is locally stored as a new illumination position or recorded as a new illumination position in the memory unit 20. Hereinafter, the display mode is controlled based on this new illumination position.

For example, if the displacement detail specifies the displacement direction and by how much divisional areas the displacement is made, the displacement detecting unit 10c shifts each illumination position specified by illumination position data in accordance with the detail of displacement (e.g., shifts the illumination position leftward by one divisional area, and downward by four divisional areas). Thereafter, identification information on a divisional area corresponding to the shifted illumination position is taken as illumination position data. Moreover, if the displacement detail specifies the rotational direction, the rotational angle, the divisional area at the center of rotation, the displacement direction after rotation and by how much divisional areas the displacement is made, the displacement detecting unit 10c rotates and shifts each illumination position specified by illumination position data in accordance with the detail of displacement (e.g., rotates the illumination position by 90 degree in the clockwise direction around a pixel at a lower left corner, and shifts it leftward by one divisional area and downward by four divisional areas). Identification information on the divisional area corresponding to the shifted illumination position is taken as illumination position data.

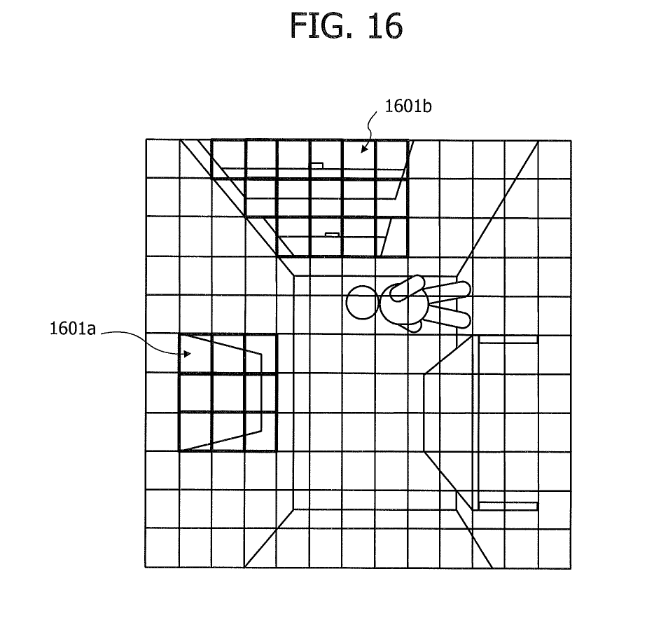

For example, according to the image shown in FIG. 14 and the image shown in FIG. 15 (the shifted image), the illumination-candidate-area groups 1501a and 1501b are shifted to the left by three divisional areas relative to the illumination-candidate-area groups 1401a and 1401b. Accordingly, the display-mode control device 2 also shifts the illumination position to the left by three divisional areas. Moreover, according to, for example, the image shown in FIG. 14 and the image shown in FIG. 16 (the shifted image), the illumination-candidate-area groups 1601a and 1601b are rotated by 90 degree in the counterclockwise direction around a divisional area at the lower left of the image in FIG. 16, and are shifted to the right by one divisional area and downward by two divisional areas relative to the illumination-candidate-area groups 1401a and 1401b. Accordingly, the display-mode control device 2 also rotates the illumination position by 90 degree in the counterclockwise direction around the divisional area at the lower left in the image, and shifts the illumination position to the right by one divisional area and downward by two divisional areas.

Thus way, the displacement detecting unit 10c corrects the illumination position. The displacement detecting process executed by the displacement detecting unit 10c completes then. Note that in addition to detecting any displacement of the display unit 40 based on picked-up image data, upon reception of various sensor data supplied when the sensor unit 80 of the display-mode control device 2 detects any displacement, rotation, and vibration of the display-mode control device 2 (including the display unit 40), the displacement detecting unit 10c may correct an illumination position through the same technique as explained above based on a displacement detail represented by the sensor data. That is, the displacement detecting unit 10c detects any displacement of the display unit 40 when receiving various sensor data. Next, based on the received sensor data, the displacement detecting unit 10c specifies a displacement detail through a conventionally well-known technique, and shifts an illumination position in accordance with the specified displacement detail.

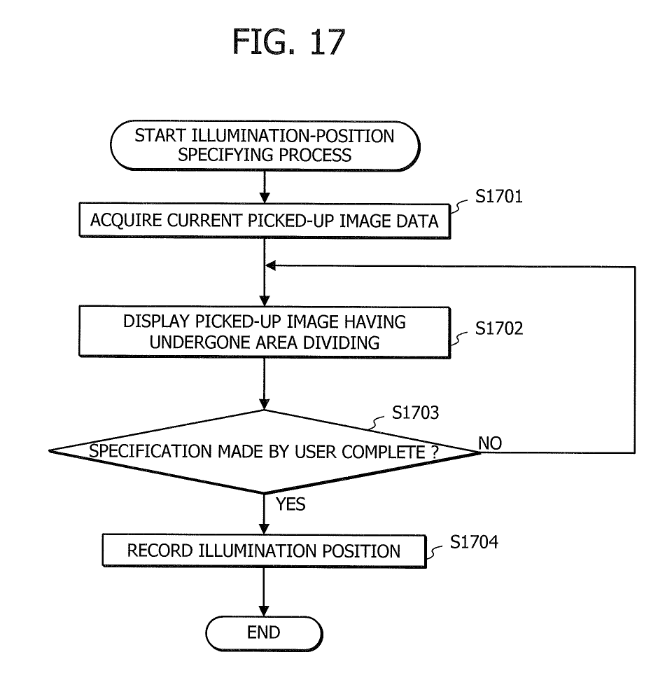

Next, with reference to FIG. 17, an explanation will be given of a process of specifying an illumination position executed by the illumination-position specifying unit 10a in response to an operation of specifying the illumination position given by a user. For example, using the input unit 50, the user turns on the display-mode control device 2, and selects activation of an illumination-position specifying mode from a screen for selecting a display control mode displayed on the display unit 40. Accordingly, the input unit 50 supplies operation input data corresponding to the operation given by the user to the controller 10, and the controller 10 receives the operation input data from the input unit 50. In response to this data reception, the illumination-position specifying unit 10a starts executing the illumination-position specifying process.

The illumination-position specifying unit 10a causes the image-pickup unit 30 to pick up an image ahead of the display face of the display unit 40, and acquires picked-up image data representing a picked-up image (step S1701). The illumination-position specifying unit 10a displays a divided image (e.g., an image having divisional areas segmented by segment lines shown in FIG. 5B) acquired by dividing the picked-up image represented by the acquired picked-up image into predetermined divisional areas on the display unit 40 (step S1702).

At this time, it is appropriate if the illumination-position specifying unit 10a executes a process of reversing an image in a minor-like manner before executing the foregoing process. That is, because the image-pickup unit 30 picks up an image in an opposite direction to a direction in which the display unit 40 is viewed, when a picked-up image ahead of the display unit 40 picked up by the image-pickup unit 30 is displayed on the display unit 40, it becomes difficult for the user to compare an actual positional relationship ahead of the display unit 40 with a positional relationship ahead of the display unit 40 displayed on the display face of the display unit 40. Accordingly, the illumination-position specifying unit 10a executes a process of reversing the picked-up image ahead of the display unit 40 in a mirror-like manner, thereby displaying the mirrored picked-up image when the picked-up image ahead of the display unit 40 picked up by the image-pickup unit 30 is displayed on the display unit 40. Accordingly, when the picked-up image (i.e., the divisional image) ahead of the display unit 40 picked up by the image-pickup unit 30 is displayed on the display face of the display unit 40, it becomes easy for the user to compare an actual positional relationship ahead of the display unit 40 with a positional relationship ahead of the display unit 40 displayed on the display unit 40.

In this state, the input unit 50 receives an operation given by the user. That is, the user can check illumination from the divisional image displayed on the display unit 40 based on the input unit 50, and can specify a divisional area including the illumination. The input unit 50 supplies identification information indicating the specified divisional area to the illumination-position specifying unit 10a. The illumination-position specifying unit 10a receives the identification information supplied from the input unit 50, and specifies, as an illumination position, a position of the divisional area specified by the received identification information. Note that if the display unit 40 and the input unit 50 shown in FIG. 11 are configured by a touch panel, the user can specify an illumination-position divisional area through the touch panel.

The illumination-position specifying unit 10a keeps receiving an operation given by the user until an operation of completing specification of the illumination-position divisional area is given (step S1703: NO). When it is detected that the user gives an operation of completing specification of the illumination-position divisional area using the input unit 50, in response to this detection (step S1703: YES), the illumination-position specifying unit 10a stores the acquired illumination position (step S1704).

As explained above, the display-mode control device 2 of the present embodiment further has the displacement detecting unit 10c that detects any displacement of the display unit 40, and the illumination-position specifying unit 10a re-specifies an illumination position again when the displacement detecting unit 10c detects any displacement. Accordingly, when the display unit 40 is displaced, rotated, or vibrated, the illumination-position specifying unit 10a starts over specifying an illumination position as needed, thereby continuing the automatic display control mode continued.

According to the display-mode control device 2 of the present embodiment, the illumination-position specifying unit 10a executes the process of specifying an illumination position in response to an operation of specifying the illumination position given by the user. That is, the display-mode control device 2 acquires picked-up image data representing a picked-up image ahead of the display face of the display unit 40, and specifies, using the acquired picked-up image data and an illumination position specifying a position of illumination in an image set beforehand, brightness at a position corresponding to an illumination position in the picked-up image as brightness of illumination. The display-mode control device 2 has display-mode controller 10b which controls the display mode in accordance with the specified brightness of illumination, and an illumination position is set beforehand in accordance with an operation of specifying the illumination position given by the user. Accordingly, it is possible for the user to specify only the illumination position that the user desires as a target of display-mode control, so that the display mode can be controlled more appropriately in accordance with the user's intension.

The display-mode control program 22 of the first and second embodiments may be recorded in a portable memory medium. An example of such portable memory medium is a CD-ROM (Compact Disk Read Only Memory) or a DVD-ROM (Digital Versatile Disk Read Only Memory). Moreover, the display-mode control program 22 may be installed in the display-mode control device 1, 2 from the portable memory medium through various reading devices. The display-mode control program 22 may be downloaded and installed in the display-mode control device 1, 2 from a network like the Internet through a communication unit (not shown). Furthermore, the display-mode control program 22 may be stored in a memory device of a server or the like communicable with the display-mode control device 1, 2, and may give an instruction to the CPU 11. The portable memory medium (e.g., a RAM, a ROM (Read Only Memory), a CD-ROM, a DVD-ROM, a hard disk, or a flash memory) storing the display-mode control program 22 is a computer-readable program product.

Having described and illustrated the principles of this application by reference to one or more preferred embodiments, it should be apparent that the preferred embodiments may be modified in arrangement and detail without departing from the principles disclosed herein and that it is intended that the application be construed as including all such modifications and variations insofar as they come within the spirit and scope of the subject matter disclosed herein.

What is claimed is:

1. A display-mode control device which controls a display mode of a display unit, the display-mode control device comprising:
an illumination-position specifying unit which acquires first picked-up image data representing a first picked-up image ahead of a display face of the display unit, specifies, using the acquired first picked-up image data, brightness at each divisional area acquired by dividing the first picked-up image, and specifies, based on the specified brightness for each divisional area, a position of a divisional area where an illumination candidate in the first picked-up image is reflected as an illumination position; and
a display-mode controller which acquires second picked-up image data representing a second picked-up image ahead of the display face of the display unit, specifies, using the acquired second picked-up image data and the illumination position specified by the illumination-position specifying unit, brightness of a divisional area located at a position corresponding to the illumination position as brightness of illumination, and controls the display mode based on the specified brightness of illumination.

2. The display-mode control device according to claim 1, wherein the illumination-position specifying unit uses the first picked-up image data representing the first picked-up image having a picked-up time that satisfies a predetermined criterion.

3. The display-mode control device according to claim 1, wherein the illumination-position specifying unit acquires the first picked-up image data multiple times, specifies the brightness for each divisional area for each piece of the first picked-up image data, and specifies, using the specified brightness, a position of a divisional area whose brightness satisfies a first criterion across the whole pieces of the first picked-up image data as the illumination position.

4. The display-mode control device according to claim 3, wherein the illumination-position specifying unit specifies, for each piece of the first picked-up image data, the divisional area whose brightness satisfies the first criterion equal to or larger than predetermined successive times as the illumination position.

5. The display-mode control device according to claim 3, wherein the illumination-position specifying unit specifies, for each piece of the first picked-up image data, a position of a divisional area having a change in brightness that satisfies a second criterion as the illumination position.

6. The display-mode control device according to claim 1, wherein the display-mode controller acquires the second picked-up image data multiple times, specifies the brightness of illumination multiple times using the acquired multiple pieces of second picked-up image data, specifies a state change in the brightness of illumination based on the specified multiple brightness of illumination, and controls the display mode based on the specified state change.

7. The display-mode control device according to claim 6, wherein when the state change is a change to a state becoming dark and when a change level of the state change satisfies a third criterion, the display-mode controller switches the display mode to a power-saving mode.

8. The display-mode control device according to claim 6, wherein when the state change is a change to a state becoming dark, the display-mode controller detects a change in brightness of a divisional area other than a divisional area corresponding to the illumination position in the second picked-up image represented by the multiple pieces of second picked-up image data, and when a change in brightness of that divisional area satisfies a fourth criterion, the display-mode controller does not switch the display mode to the power-saving mode.

9. The display-mode control device according to claim 6, wherein when the state change is a change to a state becoming bright and when a change level of the state change satisfies a fifth criterion, the display-mode controller switches the display mode from the power-saving mode to another mode.

10. The display-mode control device according to claim 1, further comprising a displacement detecting unit that detects any displacement of the display unit,
wherein the illumination-position specifying unit re-specifies the illumination position again when the displacement detecting unit detects any displacement.

11. The display-mode control device according to claim 1, further comprising an operation unit which receives an operation given by a user,
wherein the illumination-position specifying unit specifies the illumination position in accordance with an operation of the operation unit given by the user.

12. A display-mode control device which controls a display mode of a display unit, the display-mode control device comprising:
a display-mode control unit which acquires picked-up image data representing a picked-up image ahead of a display face of the display unit, specifies, using the acquired picked-up image data and a predetermined area in an image set beforehand, brightness of a position corresponding to the predetermined area in the picked-up image as brightness of illumination, and controls the display mode based on the specified brightness of illumination.

13. A recording medium storing a display-mode control program that allows a computer which controls a display mode of a display unit to execute:
an illumination-position specifying step of acquiring first picked-up image data representing a first picked-up image ahead of a display face of the display unit, of specifying, using the acquired first picked-up image data, brightness at each divisional area acquired by dividing the first picked-up image, and of specifying, based on the specified brightness for each divisional area, a position of a divisional area where an illumination candidate in the first picked-up image is reflected as an illumination position; and
a display-mode controlling step of acquiring second picked-up image data representing a second picked-up image ahead of the display face of the display unit, of specifying, using the acquired second picked-up image data and the illumination position specified in the illumination-position specifying step, brightness of a divisional area located at a position corresponding to the illumination position as brightness of illumination, and of controlling the display mode based on the specified brightness of illumination.
